(19) United States
(12) Patent Application Publication
(10) Pub. No.: US 2006/0120105 A1
(43) Pub. Date: Jun. 8, 2006

(54) System for back lighting of displays or screens

(76) Inventors: Jorg Fechner, Mainz (DE); Franz Ott, Mitterteich (DE); Brigitte Hueber, Schwandorf (DE)

Correspondence Address: TAYLOR & AUST, P.C., 142 SOUTH MAIN STREET, P. O. BOX 560, AVILLA, IN, 46710, US

(21) Appl. No.: 11/179,934

(22) Filed: Jul. 12, 2005

(30) Foreign Application Priority Data
Dec. 7, 2004 (DE) 10 2004 033 652.0
Dec. 7, 2004 (DE) 10 2004 033 653.9
Apr. 1, 2005 (DE) 10 2005 000 660.4
Apr. 1, 2005 (DE) 10 2005 000 663.9
Apr. 1, 2005 (DE) 10 2005 000 664.7
Mar. 19, 2005 (DE) 20 2005 004 487.3

(51) Int. Cl. F21V 7/04

(52) U.S. Cl. 362/607

(57) ABSTRACT

A system for backlighting of one of displays and screens including at least one light device and a light distribution unit. The at least one light device includes a glass body in the form of a hollow body with an inside and an outside. The light distribution unit containes at least one polymer. The glass body is made of a glass composition that is UV blocking and the glass body is at least partially transparent and has a transmission degree T <0.1 for wavelengths <340 nm.

### BACKGROUND OF THE INVENTION

1. Field of the invention.

The current invention relates to a system for the back lighting of displays, especially of flat displays, screens or similar equipment.

2. Description of the related art.

A conventional system for the back lighting of displays, especially flat displays, screens or similar equipment includes one or several light-emitting components, such as lights or lamps, as well as a unit which distributes the light evenly on the display or screen, a so-called light distribution unit. This light distribution unit may be in the form of a diffuser or a light guide, that is a light transporting or light transmitting plate, known as a light guiding plate (LGP), which is normally constructed of a polymer, for example a methacrylate, especially a polymethacrylate (PMMA (“Plexiglass”)).

For example, in the Patent Abstracts of Japan, application number 11-214959, a LGP is described, which possesses excellent heat and light resistance, is transparent over an extended period of time and is intended for installation into a vehicle. The plate is of a resin composition containing a polymer with an alicyclic structure and an additive that is an antioxidant, whereby the opaqueness is adjusted in the direction of the thickness to ≦1% with a shape of 3 mm.

Gas discharge lamps, especially fluorescent lamps are normally utilized as light emitting units for background lighting, also known as backlights. Many times these are mercury gas filled tubes. A mercury discharge causes UV radiation. It is known that this UV radiation causes lasting damage to polymers, that is, it influences their characteristics and appearance, thereby causing lasting impairment in their function.

Due to the emitted UV radiation the polymers turn yellow (“Yellowing”) and become opaque (“Haze”), and there is a high tendency toward brittleness. Over a period of time the brittleness of the polymers may lead to total uselessness of the entire product. An especially damaging emission line is specifically the one of mercury that serves to produce light, at 313 nm. Glass that is utilized in fluorescent lamps should therefore completely absorb this emission line, if possible.

Attempts have already been made, based on the current state of the art, to manage these problems resulting from UV radiation, by providing the lamps with a UV absorbing layer. This however requires a separate process step which adds to the manufacturing process time and causes additional costs.

Another method of preventing damage to the polymers is the introduction of UV stabilizers or absorbers into the polymer or polymers. The production of these “improved” polymers or synthetic materials is much more complex, thereby resulting in higher costs.

What is needed in the art is a system solution for the back-lighting of screens or displays whereby no damage occurs due to yellowing, haze or brittleness of polymer components within the system and whereby additional process steps, such as the application of special UV-absorbing layers onto a light emitting unit such as a lamp, or converting of polymer materials are avoided.

### SUMMARY OF THE INVENTION

The current invention relates to a system for back lighting of displays or screens including:
at least one light device that has a glass body in the form of a hollow body with an inside and an outside, as well as
a light distribution unit, essentially containing, or consisting of one or more polymers,

whereby the glass composition of the glass body is UV blocking, the glass body being at least partially transparent and having a transmission degree T <0.1 for wavelengths <340 nm.

The combined use of a light distribution unit and a light device, which possess the previously described characteristics, makes it possible to eliminate the described problems from the current state of the art. The light devices in the system of the current invention essentially have an integrated UV-protection and may therefore be combined with synthetic materials without UV-absorbers that were not additionally processed or modified and whereby the undesirable damage or impairment due to UV-radiation does not occur. This provides a simple method of providing a cost effective back-lighting system.

The light device that is used in accordance with the present invention in the form of the so-called backlight can be any light device known to the expert, for example, a discharge lamp, such as a low pressure discharge lamp, especially a fluorescent lamp, and especially preferred is a miniaturized fluorescent lamp.

A backlight lamp of this type may preferably be produced from an extruded glass tube. The light device may be broken down into a mid section and two ends. The mid section would preferably be predominantly transparent and which is in the form of a hollow glass body with an inside and an outside. The two ends can be equipped with appropriate connections by providing them with metal or metal alloy wires. It is feasible to fuse the metal or the metal wires together with the glass tube of the glass body in a tempering step. The metal, or the metal alloy wires are electrode lead-throughs and/or electrodes.

Preferably, these lead-throughs are tungsten or molybdenum metals, or kovar alloys. The thermal elongation (CTE) of the aforementioned glass composition of the glass body preferably corresponds largely with the elongation (CTE) of the aforementioned lead-throughs, so that there is no tension, or only defined and specifically targeted tension in the area of the lead-throughs. The glass of the light device contains a glass composition or consists of a composition, which provides a UV-blocking effect to the desired extent.

In addition to the light emitting device, the inventive system also includes a light distribution device. This is not particularly limited within the scope of the current invention. For example, a diffuser or a diffuser plate or panel or a light guiding or transporting plate or panel such as a LGP may be utilized.

A plate or panel of this type essentially contains one or several polymers, or consists of said polymers. Surprisingly, it is not necessary in accordance with the current invention that especially modified polymers, especially polymers which are treated with UV-protectors or stabilizers are used. On the contrary, polymeric materials which are generally used for this purpose can be directly utilized.

It is generally preferable if the polymers of the light distributing unit possess the following characteristics: suitable optical characteristics such as high transmission, low water absorption, as well as a low weight or low density. The last mentioned criterion is especially important for usage in laptops.

The selection of the polymers is not especially limited. All polymers known to the expert which possess the aforementioned characteristics may be utilized. Examples are: Polyvinylchloride (PVC), polystyrene (PS), polyethylene (PE) and polypropylene (PP), polyamide (PA), polycarbonate (PC), polymide, polyetherketone (PEK, PEEK, PAEK), polyphenylene sulfide (PPS), styrene-acrylonitrile-copolymer (SAN), polybuteneterephthalate (PBT), polymethylmethacrylate (PMMA), polycarbonate, polymer on cycloolefin base and their compounds. So-called blends or polymer alloys may also be used.

According to the current invention, polymethylmethacrylates, polycarbonates as well as one or several polymers on cycloolefin base are especially preferred.

A relatively new family of synthetic materials are polymers on cycloolefine base, such as cycloolefin-copolymers (COC), for example Topas® (thermoplastic olefin polymer of amorphous structure), or cycoolefin-polymere (COP) such as Zeonex®. Topas® for example is comprised of the basic components ethylene and norbomene. These are amorphous technical synthetic materials, which distinguish themselves through high clarity, transparency, rigidity, strength and heat resistance, as well as through superior dimensional stability and low moisture absorbency. They are, for example, approved in Europe and in the USA for food-contact applications. In addition, these materials are used for pharmaceutical blister packaging, optical precision molded components, toner fixing agents for color laser printers, medical and laboratory containers. Especially the polymers of a cycloolefin basis possess the desired characteristics and are therefore especially suitable as a polymer material for the inventively utilized light distribution unit.

The design and arrangement of the light device and the light distribution unit are, according to the present invention, not especially limited. Below, are described several inventive variations. However, the inventive theory is not being limited to these:

The system according to the current invention includes normally an especially reflective base plate or support plate, as well as a cover or substrate plate in whose immediate surrounding one or several light devices are located. According to the present invention, miniaturized backlight arrangements are preferred. Therefore, one or several individual, especially miniaturized, light devices are preferably utilized whose glass body essentially contains the UV-blocking glass types or consists of said UV-blocking glass.

In accordance with a first inventive variation, at least two light devices are located preferably parallel to each other, and are located preferably between the base or support plate and the cover or substrate plate or panel. One or several indentations are advantageously provided in the support plate in which the light device or devices are located. Preferably one indentation in each case will accommodate one light device. The transmitted light from the light device or devices is reflected on the display or the screen.

According to this variation, a reflecting layer is advantageously applied on the reflective support plate, especially in the indentation or indentations. This acts as a type of reflector and evenly scatters the light that radiates from the light device in the direction of the support plate, thereby providing a homogenous illumination of the display or screen.

Any conventional plates or panels that are normally used for this purpose may be used as a substrate or a cover plate which, depending upon system configuration and application may function as a light distributing device or merely as a cover. This arrangement, in accordance with the first inventive variation, is preferably used in larger display units, for example in televisions. The light devices, for example fluorescent tubes, may optionally be equipped with external or internal electrodes. This would depend on the selected layout.

In accordance with a second variation of the present invention, the light device may, also be located outside the light distribution unit. The light device or devices may, for example, be located outside on a display unit or screen, whereby the light is advantageously released evenly over the display or the screen by way of a LGP. Light transporting plates of this type possess a rough surface over which the light is released.

In accordance with a third variation of the inventive system a lamp system without electrodes, a so-called EEFL system (external electrode fluorescent lamp) is used. In a preferred embodiment of this inventive third variation of the present invention, the light generating unit includes an enclosed space, which is defined on top by preferably a structured panel, on the bottom by a support plate, as well as by walls on the side. For example, the light devices, such as fluorescent lamps, are located on the sides of the unit. This enclosed space is sub-divided into radiation spaces, which may contain a discharge illumination substance, which is applied to a predetermined thickness onto the support plate. An opaque diffuser plate or a clear transparent plate may be used for the cover plate or panel, depending upon the system configuration.

A backlight arrangement, in accordance with the present invention, includes a gas discharge lamp without electrodes. This means that there are no lead-throughs, only electrodes that are positioned on the outside. In principle however, internal bonding is also possible. In this instance an ignition of the plasma can occur via internal electrodes. This type of ignition represents an alternative technology. Such systems are described as CCFL systems (cold-cathode fluorescent lamp). The electrode lead-throughs may specifically comprise tungsten and molybdenum metal as a lead-through material. The arrangements previously described form a large, flat backlight and are therefore also referred to as flat backlight.

The UV-blocking effect of the glass, which is utilized in the glass body of the light device, is based on a targeted temperature treatment. It has been observed that the position of the UV-edge can be influenced by the temperature treatment of a rapidly cooled glass, which is surprisingly transparent in the visible wavelength range. In this context rapid cooling means that the glass is not subjected to a special cooling process. This means that the glass may be exposed directly to the ambient room temperature. By way of targeted cooling, or a targeted temperature after-treatment the position of the UV-edge can therefore be influenced. Therefore, blocking of UV light for wavelengths <320 nm can also be achieved for glass types having a low TiO₂ content, meaning that the UV-edge (T <0.1%, layer thickness d=0.2 mm) is at wavelengths of >260 nm, preferably >300 nm and especially preferably >313 nm, thereby blocking the especially detrimental mercury lines at 254 nm and especially at 313 nm. In this context, UV-edge is to be understood that the glass at a thickness of 0.2 mm below the cited wavelength (toward shorter wavelengths) possesses a spectral transmission degree of <0.1%.

It is especially preferable if the glass is subjected to the following temperature treatment: After melting, the glass that is utilized in accordance with the present invention and has an appropriate glass composition will be subjected to a slow cool-down. This slow cool-down takes place at cooling rates of <500 K/min, preferably <200 K/min and 100 K/min, and especially preferably <50 and 10 K/min. Alternatively, the glass will be warmed over a period of time to a temperature TH, whereby the cooling rate or the time period are selected so that the glass shows a movement of the UV-edge, compared to the rapidly cooled glass tube, especially at cooling rates >500 K/min, of more than 5 nm, especially more than 10 nm. A cooling rate is strived for that results in a glass having an UV-edge in the wavelength range of between 300 nm and 350 nm, preferably between 310 and 330 nm, and especially preferably between 313 nm and 325 nm, and that the glass is largely transparent in the wavelength range above the UV-edge. Advantageously the temperature T_{H} is in the range of Tg<T_{H}<Tg+400° C.

Especially preferred glasses for utilization in the lighting devices, which are used in accordance with the current invention are borosilicate glasses. Borosilicate glasses comprise SiO₂ as well as B₂O₃ as first components, and alkali and/or alkaline earth oxide, for example Li₂O, Na₂O, K₂O, CaO, MgO, SrO and BaO.

Borosilicate glasses having a content of B₂O₃ between 5 and 15 weight % demonstrate a high chemical stability. Furthermore, borosilicate glasses of this type can also be adapted in the thermal elongation (so called CTE) to metals, for example Wolfram (tungsten) or metal alloys, such as KOVAR by selecting the composition ranges. This avoids tensions in the area of the lead-throughs.

Borosilicate glasses having a content of B₂O₃ between 15 and 25 weight % possess excellent processing capabilities, as well as good adaptability of the thermal elongation (CTE) to the metal Wolfram (tungsten) and the alloy KOVAR (Fe—Co—Ni-alloy). When used as lamp glass, borosilicate glasses having a B₂O₃ content in the range of 25-35 weight % have a low dielectric dissipation factor tan δ which, especially when utilizing gas discharge lamps without electrodes that is lamps whose electrodes are located outside the lamp bulb, can be advantageous. The glasses can have a TiO₂ content in the range of 0-10 weight %, especially >0.5-7 weight %, preferably >1-5 weight %, especially preferably >1-4 weight %. In the instance of the herecited glasses, the sum TiO₂+B₂O₃ would especially preferably be in the range of 5-35 weight %, especially in the range of 6-25 weight %.

In a first embodiment of the present invention the base glass normally contains at least 55 weight %, or at least 60 weight % SiO₂, whereby at least 61 weight % and preferably at least 63 weight % are especially preferred. A particularly preferred minimum amount of SiO₂ has a 65 weight %. The highest amount of SiO₂ has 85 weight %, preferably 75 weight % and especially 73 weight %, whereby 72 weight % and especially a maximum of 70 weight % SiO₂ are especially preferred. According to the present invention, B₂O₃ content is preferred in an amount of more than 8 weight %, preferably more than 10 weight % and especially at least 15 weight %, whereby at least 16 weight % is especially preferred. The maximum amount of B₂O₃ is a maximum of 35 weight %, preferably however a maximum of 32 weight %, whereby a maximum 30 weight % is especially preferred.

Al₂O₃ is preferably present at 0-25 weight %, preferably at 0-10 weight %, whereby a minimum amount of 0.5 weight % or 1 weight % and especially 2 weight % is preferred. The maximum amount is normally 5 weight %, preferably 3 weight %. The individual alkali oxides Li₂O, Na₂O as well as K₂O each amount usually independently of each other to 0-20, or 0-10 weight %, whereby a minimum amount of 0.1 weight %, or 0.2 and especially 0.5 weight % is preferred. The maximum amount of individual alkali oxides is preferably a maximum of 8 weight %, whereby an amount of Li₂O of 0.2 weight % to 1 weight %, for Na₂O 0.2 weight % to 3 weight %, especially to 1.5 weight % and for K₂O 0.5-8 weight %, especially 6-8 weight % is preferred. The sum of alkali oxides in the base glass in accordance with the invention is 0-25 weight % and especially 0.5-5 weight %. Alkaline earth oxides such as MgO, CaO, SrO are, according to the present invention, always contained in an amount of 0-20 weight % and especially in an amount of 0-8 weight % or 0-5 weight %. BaO may preferably be present in an amount of 0-45 weight %. The sum of the alkaline earth oxides amounts according to the present invention to 0-45 weight %, especially 0-20 weight %, preferably 0-10 weight %. In a particularly advantageous design form they amount together to at least 0.5 weight % or >1 weight %.

In addition, the base glass in accordance with a first design contains preferably 0-30, especially preferably 0-10, particularly 0-3 weight % ZnO, 0-3 or 0-5 weight % ZrO₂, 0-1 or 0-0.5 weight % CeO₂ as well as 0-1 weight % or 0-0.5 weight % Fe₂O₃. In addition, WO₃, Bi₂O₃, MoO₃ can, independent from each other, each be present in an amount of 0-5 weight % or 0-3 weight %, especially however 0.1-3 weight %.

It has been shown that, even though the glasses are very stable against solarization during UV radiation, the solarization stability may be enhanced even further through low contents of PdO, PtO₃, PtO₂, PtO, RhO₂, Rh₂O₃, IrO₂ and/or Ir₂O₃. The normal maximum content of such substances is normally max. 0.1 weight %, preferably a maximum of 0.01 weight % and a maximum of 0.001 weight % is especially preferred. The minimum content for these purposes is normally 0.01 ppm, with at least 0.05 ppm and especially at least 0.1 ppm is preferred.

Even though the glasses may contain small amounts of CeO₂, PbO and Sb₂O₃ for the purpose of increasing the chemical stability, refining and processability it is preferable if they are free of these substances.

If there is an iron content then this will be converted into its oxidation stage +3 due to the oxidizing conditions during the melting process, for example through the utilization of nitrate containing raw materials. Discolorations in the visible wavelength range are thereby reduced. The preferred amount of Fe₂O₃ in the glass is <500 ppm. Fe₂O₃ is normally present in the form of contaminations. Fe₂O₃ may however, also be introduced deliberately for the purpose of adjusting the UV edge. In this scenario the added content would be between 10-500 ppm preferably 50-200 ppm, and especially preferably 70-150 ppm.

If the TiO₂ content of the glass composition is >2 weight % and a glass mixture batch having a total Fe₂O₃ content of >5 ppm is used, then it is preferable if the mixture is refined with As₂O₃ and melted with nitrate. The addition of nitrate would preferably be in the form of alkali nitrate with contents of >1 weight %, in order to suppress coloring of the glass in the visible range.

It has been found specifically with glass that contains TiO₂ in concentrations of >1.0 weight %, that a discoloration of the glass, specifically in the visible wavelength range can be avoided at least partially in that the melted glass is essentially chloride-free, and that specifically no chloride and/or Sb₂O₃ is added for refining during the glass melting process. It had been found that a blue coloration of the glass, as occurs especially when TiO₂ is used can be avoided if no chloride is used as a refining agent. According to the present invention, the maximum content of chloride as well as fluoride is 2, especially 1 weight %, whereby contents of 0.1 weight % max. is preferred.

It has further been demonstrated that sulfates, such as are used as refining agents, like the previously referred to substances also lead to a discoloration in the visible wavelength range in the glass. It is therefore preferable if the use of sulfates is also avoided. According to the invention the maximum sulfate content is 2 weight %, especially 1 weight %, whereby contents of 0.1 weight % max. is preferred.

If glasses contain TiO₂ in an amount of <1.0 weight %, then the conventional refining agents like chloride, sulfates, Sb₂O₃ may be used.

The visible wavelength range in the present application is to be understood to be the wavelength range between 380 nm and 780 nm.

In addition it has been found that the previously described disadvantages relating to the glass can be further avoided if refining is conducted under oxidizing conditions with As₂O₃. The glass would preferably contain 0.01-1 weight % As₂O₃.

Preferably at least 80%, normally at least 90%, preferably at least 95% and especially 99% of the contained TiO₂ is in the form of Ti⁴⁺. In many instances as much as even 99.9 and 99.99% of titanium is present in the form of Ti⁴⁺. In some instances Ti⁴⁺ contents of 99.999% have proven to be significant. Oxidative conditions are to be understood especially to be conditions where Ti⁴⁺ is present in the previously cited amounts or where oxidation occurs to this level.

These oxidative conditions can be easily achieved in the melted glass, for example through the addition of nitrates, especially alkali nitrates and/or alkali earth nitrates. An oxidative melted mass can also be achieved by blowing oxygen and/or dry air into it. It is also possible to produce an oxidative melted mass by way of an oxidizing burner adjustment, for example through the melting of the glass batch.

Through oxidative refining, for example by utilizing nitrates with As₂O₃, formation of the ilmenite (FeTiO₃) complex can especially be prevented. Occurrence of this complex results in considerable coloration in the visible range.

Even though nitrate, preferably in the form of alkali and/or alkali earth nitrate is added to the glass during the melting process, the NO₃ concentration in the finished glass after refining amounts to only 0.01 weight %, and in many instances to 0.001 weight % at most.

The composition of the inventive glass types is in the following range:

| | | |
|---|---|---|
| SiO₂ | 55-85 | weight % |
| B₂O₃ | >0-35 | weight % |
| Al₂O₃ | 0-10 | weight % |
| Li₂O | 0-10 | weight % |
| Na₂O | 0-20 | weight % |
| K₂O | 0-20 | weight %, whereby the |
| Σ Li₂O + Na₂O + K₂O | 0-25 | is weight %, and |
| MgO | 0-8 | weight % |
| CaO | 0-20 | weight % |
| SrO | 0-5 | weight % |
| BaO | 0-45 | weight %, especially |
| BaO | 0-5 | weight %, whereby the |
| Σ MgO + CaO + SrO + BaO | 0-45 | weight %, |
| Especially | 0-20 | Weight and |
| TiO₂ | 0-10 | Weight %, |
| Preferably | >0.5-10 | Weight % |
| ZrO₂ | 0-3 | Weight % |
| CeO₂ | 0-1 | Weight-% |
| Fe₂O₃ | 0-1 | Weight % |
| WO₃ | 0-3 | Weight % |
| Bi₂O₃ | 0-3 | Weight % |
| MoO₃ | 0-3 | Weight %. |

The inventive light devices are preferably sleeve type glasses having the following composition:

| | | |
|---|---|---|
| SiO₂ | 55-79 | Weight % |
| B₂O₃ | 3-25 | Weight % |
| Al₂O₃ | 0-10 | Weight % |
| Li₂O | 0-10 | Weight % |
| Na₂O | 0-10 | Weight % |
| K₂O | 0-10 | Weight % whereby the |
| Σ Li₂O + Na₂O + K₂O | 0.5-16 | Is Weight % and |
| MgO | 0-2 | Weight 1% |
| CaO | 0-3 | Weight % |
| SrO | 0-3 | Weight % |
| BaO | 0-45 | Weight %, especially |
| BaO | 0-3 | Weight % |
| ZnO | 0-30 | Weight %, especially |
| ZnO | 0-3 | Weight %, whereby |
| | | the |
| Σ MgO + CaO + SrO + BaO + ZnO | 0-30 | Is Weight-%, |
| Especially | 0-20 | Weight and |
| TiO₂ | 0-10 | Weight %, |
| Preferably | >0.5-10 | Weight % |
| ZrO₂ | 0-3 | Weight % |
| CeO₂ | 0-1 | Weight-% |
| Fe₂O₃ | 0-1 | Weight % |
| WO₃ | 0-3 | Weight % |
| Bi₂O₃ | 0-3 | Weight % |
| MoO₃ | 0-3 | Weight %. |

The inventive light devices are preferably sleeve type glasses having the following composition:

| | | |
|---|---|---|
| SiO₂ | 55-79 | Weight % |
| B₂O₃ | 3-25 | Weight % |
| Al₂O₃ | 0-10 | Weight % |
| Li₂O | 0-10 | Weight % |
| Na₂O | 0-10 | Weight % |
| K₂O | 0-10 | Weight % whereby the |
| Σ Li₂O + Na₂O + K₂O | 0.5-16 | Is Weight % and |
| MgO | 0-2 | Weight 1% |
| CaO | 0-3 | Weight % |
| SrO | 0-3 | Weight % |
| BaO | 0-45 | Weight %, especially |
| BaO | 0-3 | Weight % |
| ZnO | 0-30 | Weight %, especially |
| ZnO | 0-3 | Weight %, whereby the |
| Σ MgO + CaO + SrO + BaO + ZnO | 0-30 | Is Weight-%, |
| Especially | 0-10 | Weight % and |
| ZrO₂ | 0-3 | Weight % |
| CeO₂ | 0-1 | Weight % |
| Fe₂O₃ | 0-1 | weight % |
| WO₃ | 0-3 | weight % |
| Bi₂O₃ | 0-3 | weight % |
| MoO₃ | 0-3 | weight % |
| whereby the melted mass | 0.1-10 | weight % TiO₂ |
| contains | | |

and the melted mass is produced under oxidative conditions. This glass composition preferably contains 0.01-1 weight % As₂O₃.

In addition, for light devices where the electrodes are on the outside and where no fusing of the glass with the electrode lead-throughs occurs, the aforementioned glass compositions may also be utilized. These are the so-called EEFLs (external electrode fluorescent lamp). These types of EEFL-light devices are light devices without electrode lead-throughs. With EEFL backlights without electrodes the connection of the light occurs with the assistance of electric fields. Therefore, glass compositions are especially suitable that distinguish themselves through good electrical characteristics. Such types of glass are, for example, of the following composition, which can be added to the first design variation, described above:

| | | |
|---|---|---|
| SiO₂ | 60-75 | Weight % |
| B₂O₃ | >25-35 | Weight % |
| Al₂O₃ | 0-10 | Weight % |
| Li₂O | 0-10 | Weight-% |
| Na₂O | 0-20 | Weight % |
| K₂O | 0-20 | Weight %, whereby the |
| Σ Li₂O + Na₂O + K₂O | 0-25 | is Weight and |
| MgO | 0-8 | Weight % |
| CaO | 0-20 | Weight % |
| SrO | 0-5 | Weight % |
| BaO | 0-45 | Weight, especially |
| BaO | 0-5 | Weight %, whereby the |
| Σ MgO + CaO + SrO + BaO | 0-45 | Weight %, |
| especially | 0-20 | Is Weight %, and |
| ZnO | 0-30 | Weight %, especially |
| ZnO | 0-3 | Weight %, and |
| ZrO₂ | 0-5 | Weight % |
| TiO₂ | 0-10 | Weight % |
| Fe₂O₃ | 0-0.5 | Weight % |
| CeO₂ | 0-0.5 | Weight % |
| MnO₂ | 0-1 | Weight % |
| Nd₂O₃ | 0-1 | Weight % |
| WO₃ | 0-2 | Weight % |
| Bi₂O₃ | 0-5 | Weight % |
| M₂O₃ | 0-5 | Weight % |
| As₂O₃ | 0-1 | Weight % |
| Sb₂O₃ | 0-1 | Weight % |
| SO₄²⁻ | 0-2 | Weight % |
| CI⁻ | 0-2 | Weight % |
| F⁻ | 0-2 | Weight %, whereby the |

Σ Fe₂O₃, CeO₂, TiO₂, PbO + As₂O₃ + Sb₂O₃ 0-10 is weight % and whereby Σ PdO + PtO₃ + PtO₂ + PtO + RhO₂ + Rh₂O₃ + IrO₂ + Ir₂O₃ is 0.00001-0.1 weight %.

According to an especially advantageous design form of the invention, the glass, especially for gas discharge lamps is designed with electrodes on the outside.

In order to achieve as low a power loss Pₗₒₛₛ as possible when using the gas discharge lamps with the electrodes on the outside, and therefore a high efficiency level, it was noticed that it is especially advantageous if the quotient from the loss angle tan δ and the relative permittivity ε′ is relatively low. For a simple geometry with planar electrodes on the faces of an enclosed glass tube, the power loss can be approximated as described below:

$${P}_{loss} \approx 2 \cdot \frac{1}{ω} \cdot \frac{tan δ}{{ɛ}^{′}} \cdot \frac{d}{A} \cdot {I}^{2}$$

Whereby
ω: Radian frequency
tan δ: Loss angle
ε′ Relative permittivity
d: Thickness of capacitor (here thickness of glass)
A: Electrode surface
I: Intensity of current

When using for EEFL the quotient therefore should be

$$\frac{tan δ}{{ɛ}^{′}} < 5 ,$$

preferably <4, especially preferably <3, more especially preferably <2.5, particularly <1.5 and even more particularly preferably <1. The setting of the quotient tan δ/ε′ in a range of less than 5, directly targets the glass characteristics, resulting in that the desired total power loss is minimized.

In order to set the quotient from tan δ and ε′ as low as possible, the glass composition contains highly polarizable elements in oxidic form, integrated into the glass matrix. Such highly polarizable elements in oxidic form may be selected from the group consisting of the oxides of Ba, Cs, Hf, Ta, W, Re, Os, Ir, Pt, Pb, Bi, La, Ce, Pr, Nd, Sm, Eu, Gd, Th, Dy, Ho, Er, Tm, Yb and/or Lu.

It is advantageous if at least one of these oxides is contained in the glass composition. Mixtures of two or more of these oxides are also feasible. At least one of these oxides is preferably contained in an amount of >0 to 80 weight %, preferably of 5 to 75, especially preferably 10 to 70 weight %, particularly 15 to 65 weight %. An additional preference are 15 to 60 weight %, 20 to 55 or 20 to 50 weight %. Even more preferable are 20 to 45 weight %, especially 20 to 40 weight % or 20 to 35 weight %. In the most advantageous situation 15, especially 18, and preferably 20 weight % are the minimum.

It is especially preferred if Cs₂O, BaO, PbO, Bi₂O₃, as well as the rare earth metal oxides lanthanum oxide, gadolinium oxide and/or ytterbium oxide are contained in the glass composition according to the invention. Especially preferred is a contents of at least 15 weight %, even more preferable is 18 weight %, especially 20 weight %, and particularly preferred more than 25 weight % of one or more of the highly polarizable elements in oxide form in the glass composition.

In accordance with this embodiment according to the present invention, the CeO₂ content is preferred at 0-6 weight %, whereby amounts of 0-1 and especially 0-0.5 weight % are preferred. The Nd₂O₃ content is preferably 0-5 weight %, whereby amounts of 0-2, especially 0-1 weight % are especially favorable. The preferred amount of Bi₂O₃ would be 0-80 weight %, preferably from 5-75, especially preferably 10 to 70 weight %, particularly 15 to 65 weight %. An additional preference is 15 to 65 weight %, 20 to 55 or 20 to 50 weight %. Even more preferable are 20 to 45 weight %, especially 20 to 40 weight % or 20 to 35 weight %. The addition of at least one of these polarizable oxides at the above referenced surprisingly high volumes can therefore specifically target the glass characteristics in a manner that clearly reduces the total power loss to an absolute minimum, as compared to glass that is normally used in light devices with electrodes on the outside.

In accordance with the current invention the sum of all earth alkali oxides then amounts to preferably 0-80 weight %, especially 5-75 weight %, preferably 10-70 weight %, especially preferably 20-60 weight % and more especially preferably 20-55 weight %. Also preferred are 20-40 weight %. For this design variation it has been particularly advantageous if the sum Al₂O₃+B₂O₃+Cs₂O+BaO+Bi₂O+PbO is in the range of 15 to 80 weight %, preferably in the range of 15 to 75 weight %, especially 20 to 70 weight %. Since the maximum amount of B₂O₃ used is normally 35 weight %, the remaining 45 weight % are distributed over one or several of the polarizable oxides BaO, Bi₂O₃, Cs₂O and PbO. The PbO content can advantageously be set to 0 to 70 weight %, preferably 10-65 weight %, and more preferably 15-60 weight %, Particularly preferable is a content of 20 to 58 weight %, 25 to 55 weight %, and especially 35 to 50 weight %. If the PbO content is set to above 50 weight %, especially above 60 weight %, the alkaline contents of more than 3 weight %, especially more than 4 weight % or more than 5 weight % can be added to the glass, whereby the content should not exceed 10 weight %, whereby in spite of this however, the requirements upon the quotient tan δ/ε′ of <5 is still met. If the inventive glass types which are specially designed for use in EEFL lamps do not contain PbO, then they would preferably be free of alkalis, according to the invention.

For use in EEFL lamps the glass would therefore preferably be of the following composition:

| | | |
|---|---|---|
| SiO2 | 55-85 | Weight % |
| B2O3 | >0-35 | Weight % |
| Al₂O₃ | 0-25 | Weight % |
| Preferably | 0-20 | Weight % |
| Li₂O | <1.0 | Weight % |
| Na₂O | <3.0 | Weight % |
| K₂O | <5.0 | Weight % whereby |
| Σ Li₂O + Na₂O + K₂O | <5.0 | is Weight %, and |
| MgO | 0-8 | Weight % |
| CaO | 0-20 | Weight % |
| SrO | 0-20 | Weight % |
| BaO | 0-80 | Weight %, especially |
| BaO | 0-60 | Weight % |
| TiO₂ | 0-10 | Weight % is |
| preferably | >0.5-10 | Weight % |
| ZrO₂ | 0-3 | Weight % |
| CeO₂ | 0-10 | Weight % |
| Fe₂O₃ | 0-3 | Weight % |
| preferably | 0-1 | Weight % |
| WO₃ | 0-3 | Weight % |
| Bi₂O₃ | 0-80 | Weight % |
| MoO₃ | 0-3 | Weight % |
| ZnO | 0-15 | Weight % |
| preferably | 0-5 | Weight % |
| PbO | 0-70 | Weight %, whereby |

the ΣAl₂O₃ + B₂O₃ + BaO + PbO + Bi₂O₃ is 15-80 weight %, whereby Hf, Ta, W, Re, Os, Ir, Pt, La, Pr, Nd, Sm, Eu, Gd, Tb, Dy, Ho, Er, Tm, Yb and/or Lu are present in oxidic form at a content of 0-80 weight %, as well as refining agents in the usual concentrations.

The glass is preferably free of alkalis, except for unavoidable impurities. An especially preferred design variation for use in sleeve type glasses in EEFL lamps is:

| | | |
|---|---|---|
| SiO₂ | 55-85 | Weight % |
| B₂O₃ | >0-35 | Weight % |
| Al₂O₃ | 0-20 | Weight % |
| Li₂O | <0.5 | Weight % |
| Na₂O | <0.5 | Weight % |
| K₂O | <0.5 | Weight %, whereby |
| Σ Li₂O + Na₂O + K₂O | <1.0 | is Weight %, and |
| MgO | 0-8 | Weight % |
| CaO | 0-20 | Weight % |
| SrO | 0-20 | Weight % |
| BaO | 15-60 | Weight %, especially |
| BaO | 20-35 | Weight %, whereby |
| Σ MgO + CaO + SrO + BaO | 15-70 | Weight % |
| especially | 20-40 | Weight %, and |
| TiO₂ | 0-10 | Weight % |
| Is preferably | >0.5-10 | Weight % |
| ZrO₂ | 0-3 | Weight % |
| CeO₂ | 0-10 | Weight % |
| Is preferably | 0-1 | Weight % |
| Fe₂O₃ | 0-1 | Weight % |
| WO3 | 0-3 | Weight % |
| Bi₂O₃ | 0-80 | Weight % |
| MoO₃ | 0-3 | Weight % |
| ZnO | 0-10 | Weight % |
| Preferaly | 0-5 | Weight % |
| PbO | 0-70 | Weight %, whereby |

the Σ Al₂O₃ + B₂O₃ + BaO + Cs₂O + PbO + Bi₂O₃ is 15-80 weight %, as well as refining agents in the usual concentrations.

The glass is preferably free of alkalis, except for unavoidable impurities. Additional preferred glass compositions for use in EEFL lamps include:

| | | |
|---|---|---|
| SiO₂ | 35-65 | Weight % |
| B₂O₃ | 0-15 | Weight % |
| Al₂O₃ | 0-20 | Weight % |
| Preferably | 5-15 | Weight % |
| Li₂O | 0-0.5 | Weight % |
| Na₂O | 0-0.5 | Weight % |
| K₂O | 0-0.5 | Weight %, whereby the |
| Σ Li₂O + Na₂O + K₂O | 0-1 | Is Weight %, and |
| MgO | 0-6 | Weight % |
| CaO | 0-15 | Weight % |
| SrO | 0-8 | Weight % |
| BaO | 1-20 | Weight %, especially |
| BaO | 1-10 | Weight % |
| TiO₂ | 0-10 | Weight % |
| is preferably | >0.5-10 | Weight % |
| ZrO₂ | 0-1 | Weight % |
| CeO₂ | 0-0.5 | Weight % |
| Fe₂O₃ | 0-0.5 | Weight % |
| WO₃ | 0-2 | Weight % |
| Bi₂O₃ | 0-20 | Weight % |
| MoO₃ | 0-5 | Weight % |
| ZnO | 0-5 | Weight % |
| Preferably | 0-3 | Weight % |
| PbO | 0-70 | Weight %, whereby |

the Σ Al₂O₃ + B₂O₃ + BaO + PbO + Bi₂O₃ is 8-65 weight %, whereby Hf, Ta, W, Re, Os, Ir, Pt, La, Pr, Nd, Sm, Eu, Gd, Tb, Dy, Ho, Er, Tm, Yb and/or Lu are present in oxidic form at a contents of 0-80 weight %, as well as refining agents in the usual concentrations.

Additional glasses which—like the aforementioned glass compositions also have a quotient of tanδ/ε′<5 due to the presence of at least one highly polarizable oxide at relatively high amounts, and which are especially advantageous for use in EEFL lamps has the following composition:

| | | |
|---|---|---|
| SiO₂ | 50-65 | Weight % |
| B₂O₃ | 0-15 | Weight % |
| Al₂O₃ | 1-17 | Weight % |
| Li₂O | 0-0.5 | Weight % |
| Na₂O | 0-0.5 | Weight % |
| K₂O | 0-0.5 | Weight %, whereby the |
| Σ Li₂O + Na₂O + K₂O | 0-1 | Is Weight %, and |
| MgO | 0-5 | Weight % |
| CaO | 0-15 | Weight % |
| SrO | 0-5 | Weight % |
| BaO | 20-60 | Weight %, especially |
| BaO | 20-40 | Weight % |
| TiO₂ | 0-1 | Weight % |
| ZrO₂ | 0-1 | Weight % |
| CeO₂ | 0-0.5 | Weight % |
| Fe₂O₃ | 0-0.5 | Weight % |
| Preferably | 0-1 | Weight % |
| WO₃ | 0-2 | Weight % |
| Bi₂O₃ | 0-40 | Weight % |
| MoO₃ | 0-5 | Weight % |
| ZnO | 0-3 | Weight % |
| PbO | 0-30 | Weight %, especially |
| PbO | 10-20 | Weight %, whereby |

the ΣAl₂O₃ + B₂O₃ + BaO + PbO + Bi₂O₃ is 10-80 weight %, whereby Hf, Ta, W, Re, Os, Ir, Pt, La, Pr, Nd, Sm, Eu, Gd, Tb, Dy, Ho, Er, Tm, Yb and/or Lu are present in oxidic form at a content of 0-80 weight %, as well as refining agents in the usual concentrations.

In addition, the following glass compositions are preferred, independent of the used light devices:

| | | |
|---|---|---|
| SiO₂ | 63-72 | Weight % |
| B₂O₃ | 15-22 | Weight % |
| Al₂O₃ | 0-3 | Weight % |
| Li₂O | 0-5 | Weight % |
| Na₂O | 0-5 | Weight % |
| K₂O | 0-5 | Weight %, whereby the |
| Σ Li₂O + Na₂O + K₂O | 0.5-5 | Is Weight %, and |
| MgO | 0-3 | Weight % |
| CaO | 0-5 | Weight % |
| SrO | 0-3 | Weight % |
| BaO | 0-30 | Weight %, especially |
| BaO | 0-3 | Weight %, whereby the |
| Σ MgO + CaO + SrO + BaO | 0-30 | Weight % is |
| especially | 0-5 | Weight %, and |
| ZnO | 0-30 | Weight %, especially |
| ZnO | 0-3 | Weight % |
| ZrO₂ | 0-5 | Weight % |
| TiO₂ | >0.5-10 | Weight % |
| Fe₂O₃ | 0-0.5 | Weight % |
| CeO₂ | 0-0.5 | Weight % |
| MnO₂ | 0-1.0 | Weight % |
| Nd₂O₃ | 0-1.0 | Weight % |
| WO₃ | 0-2 | Weight % |
| Bi₂O₃ | 0-5 | Weight % |
| MoO₃ | 0-5 | Weight % |
| As₂O₃ | 0-1 | Weight % |
| Sb₂O₃ | 0-1 | Weight % |
| SO₄⁽²⁻⁾ | 0-2 | Weight % |
| Cl⁻ | 0-2 | Weight % |
| F⁻ | 0-2 | Weight %, whereby |

Σ Fe₂O₃, CeO₂, TiO₂, PbO + As₂O₃ + Sb₂O₃ is 0.5-10 Weight %

An additional preferred composition contains:

| | | |
|---|---|---|
| SiO₂ | 67-74 | Weight % |
| B₂O₃ | 5-10 | Weight % |
| Al₂O₃ | 3-10 | Weight % |
| Li2O | 0-4 | Weight % |
| Na₂O | 0-10 | Weight % |
| K₂O | 0-10 | Weight %, whereby |
| | | the |
| Σ Li₂O + Na₂O + K₂O | 0.5-10.5 | Is Weight % |
| MgO | 0-2 | Weight % |
| CaO | 0-3 | Weight % |
| SrO | 0-3 | Weight % |
| BaO | 0-30 | Weight %, especially |
| BaO | 0-3 | Weight % |
| ZnO | 0-30 | Weight %, especially |
| ZnO | 0-3 | Weight %, whereby |
| | | the |
| Σ MgO + CaO + SrO + BaO + ZnO | 0-30 | Weight % |
| is especially | 0-6 | Weight % |
| ZrO₂ | 0-3 | Weight % |
| CeO₂ | 0-1 | Weight % |

and that TiO₂, Bi₂O₃ and/or MoO₃ are contained in an amount, always independent of each other, 10 of 0-10 weight %, whereby Σ TiO₂+Bi₂O₃+MoO₃ are 0.1-10 weight %.

All aforementioned glass composition contain preferably the previously cited amounts of Fe₂O₃ and are essentially especially preferably free of FeO.

The following glass compositions are also especially suitable for light devices, especially lamps with electrodes on the outside, having electrode lead-throughs, whereby no fusing into the glass occurs. In addition they distinguish themselves through a high chemical resistance to acids, caustic solutions and water and are to be added to the invention in a second design variation:

| | | |
|---|---|---|
| SiO₂ | 60-85 | Weight % |
| B₂O₃ | 0-10 | Weight % |
| Al₂O₃ | 0-10 | Weight % |
| Li₂O | 0-10 | Weight % |
| Na₂O | 0-20 | Weight % |
| K₂O | 0-20 | Weight %, whereby the |
| Σ Li₂O + Na₂O + K₂O | 5-25 | is Weight % and |
| MgO | 0-8 | Weight % |
| CaO | 0-20 | Weight % |
| SrO | 0-5 | Weight % |
| BaO | 0-30 | Weight %, especially |
| BaO | 0-5 | Weight % m whereby the |
| Σ MgO + CaO + SrO + BaO | 3-30 | Weight % |
| is especially | 3-20 | Weight %, and |
| ZnO | 0-20 | Weight %, especially |
| ZnO | 0-8 | Weight % |
| ZrO₂ | 0-5 | Weight % |
| TiO₂ | 0-10 | Weight % |
| Fe₂O₃ | 0-5 | Weight % |
| CeO₂ | 0-5 | Weight % |
| MnO₂ | 0-5 | Weight % |
| Nd₂O₃ | 0-1.0 | Weight % |
| WO₃ | 0-2 | Weight % |
| Bi₂O₃ | 0-5 | Weight % |
| MoO₃ | 0-5 | Weight % |
| PbO | 0-5 | Weight % |
| As₂O₃ | 0-1 | Weight % |
| Sb₂O₃ | 0-1 | Weight % |

whereby the
Σ Fe₂O₃ + CeO₂ + TiO₂ + PbO + As₂O₃ + Sb₂O₃
is 0-10 weight %
and whereby the
Σ PdO + PtO3 + PtO2 + PtO + RhO2 + Rh2O3 + IrO2 + Ir2O3
is 0.1 weight %, as well as

| | | |
|---|---|---|
| SO₄²⁻ | 0-2 | Weight % |
| Cl⁻ | 0-2 | Weight % |
| F⁻ | 0-2 | Weight % |

The second design form of a glass that is suitable for a light device of the invention has a minimum content of SiO₂ of at least 60 weight %, preferably at least 62 weight %, whereby a minimum content of 64 weight % is particularly preferred. The minimum content of SiO₂ in the inventive glass is at most 85 weight %, especially 79 weight %, whereby a content of 75 weight % maximum is preferred. An especially preferred maximum content is 72 weight %. Glass having a very high SiO₂ content distinguishes itself through a low dielectric dissipation factor tan δ and may therefore be suitable for fluorescent lamps without electrodes.

The B₂O₃ content is 10 weight % maximum, especially 5 weight % maximum, whereby a content of 4 weight % maximum is preferred. A maximum content of B₂O₃ of 3 weight % at most is especially preferred, whereby a content of 2 weight % is especially preferred. In individual cases, the inventive glass may also be completely B₂O₃ free. However, in a preferred embodiment it contains at least 0.1 weight %, whereby 0.5 weight % is preferred. Especially preferred is a minimum content of 0.75 weight %, whereby at least 0.9 weight % is particularly preferable.

Even though the glass may, in accordance with the second embodiment, be Al₂O₃ free in some individual instances, it does however normally contain at least 0. 1, especially 0.2 weight % Al₂O₃. A minimum amount of 0.3 is preferred, whereby minimum amounts of 0.7, especially at least 1.0 weight % are preferred. The highest Al₂O₃ content is normally 10 weight %, whereby a maximum of 8 weight % is preferred. In many instances a maximum amount of 5 weight %, especially 4 weight % has proven sufficient.

The glass according to the second embodiment contains alkali and alkaline earth oxides. The total alkaline oxide contents amounts to at least 5 weight %, especially at least 6 weight %, preferably however at least 8 weight %, whereby a minimum total amount of at least 10 weight % alkaline oxides is preferred. The maximum content of all alkaline oxides amounts to 25 weight % at most, whereby a maximum of 22 weight % and especially 20 weight % is especially preferred. In many instances a maximum amount of 18 weight % has been sufficient. The Li₂O content, according to the invention is 0 weight % to 10 weight % at most, whereby a maximum amount of 8 weight % and especially a maximum of 6 weight % is preferable. K₂O is contained in an amount of at least 0 weight % and at most 20 weight %, whereby a minimum content of 0.01 weight %, preferably 0.05 weight % is preferred. In individual instances a minimum content of 1.0 weight % has proven to be suitable. In a preferred embodiment the maximum K₂O content is 18 weight %, whereby a maximum of 15 and especially a maximum of 10 weight % is preferred. In many instances a maximum content of 5 weight % has been completely sufficient.

In individual instances the minimum Na₂O content is 0 weight % and a maximum of 20 weight %. The Na₂O content should however preferably be at least 2 weight %, especially 5 weight %, whereby contents of at least 8 weight % and especially at least 10 weight % are preferable. In particularly preferred embodiments, sodium oxide is present in an amount of at least 12 weight %. Preferred maximum amounts of Na₂O are 18 weight % or 16 weight %, whereby an upper limit of 15 weight % is especially preferred.

In an application for fluorescent lamps with the electrodes on the outside, the glass is preferably free of alkalis.

The content of individual alkaline earth oxides is a maximum of 20 weight % for CaO; in individual instances however, maximum contents of 18, especially a maximum of 15 weight % is sufficient. Even though the inventive glass may also be free of calcium components it does however usually contain at least 1 weight % CaO, whereby contents of at least 2 weight %, especially 3 weight % are preferred. In practical applications a minimum content of 4 weight % has been advantageous. The lower limit for MgO is, in individual instances 0 weight %, whereby however at least 1 weight % and preferably at least 2 weight % are preferred. The maximum amount of MgO in the glass according to the invention is 8 weight %, whereby a maximum of 7 and especially a maximum of 6 weight % is preferred. SrO and/or BaO may be totally eliminated from the glass according to the invention; however, at least one or even both substances would preferably be represented in an amount of 1 weight %, preferably at least 2 weight % each. The total content of all alkaline earth oxides contained in the glass amounts to at least 3 weight % and at most 30 weight %, especially 20 weight %, whereby a minimum content of 4 weight %, especially 5 weight % is preferred. Minimum contents of 6 or 7 weight % have proven favorable in many instances. One preferred maximum limit of alkaline earth oxides is 18 weight %, whereby a maximum of 15 weight % is preferred.

In several instances a maximum content of 12 weight % has been established to be sufficient.

In accordance with the second embodiment the glass may be free of ZnO. It would however preferably contain a minimum amount of 0.1 weight % and a maximum content of 30 weight % at most, especially 8 weight %, preferably 5 weight % at most, whereby maximum contents of 3 weight % or 2 weight % may be absolutely practical. The ZrO₂ content is 0-8 weight %, especially 0-5 weight %, whereby a maximum content of 3 weight % has proven to be sufficient in many instances.

The glass, in accordance with the second embodiment, also distinguishes itself in a preferred design form through a total content of TiO₂, PbO, As₂O₃ and/or Sb₂O₃ of at least 0.1 weight % and a maximum amount of 2 weight %, especially a maximum of 1 weight %. However, the preferred minimum content of As₂O₃ and/or Sb₂O₃ is at least 0.01 weight %. Preferably at least 0.05 weight % and especially at least 0.1 weight %. The normal maximum amount is 2 weight %, especially a maximum of 1.5 weight %, whereby a maximum of 1 weight % and especially 0.8 weight % are particularly preferred.

From the list of the aforementioned elements, a TiO₂ content in the inventive glass is especially desirable, even though not absolutely necessary as long as the contents of the other aforementioned components is correspondingly higher. The maximum content of TiO₂ would preferably be 8 weight %, whereby 5 weight % at most are preferred. A preferred minimum content of TiO₂ is 1 weight %. The glass contains 0-5 weight % PbO, whereby a maximum content of 2 weight %, especially a maximum of 1 weight % are appropriate. The glass is preferably lead free. The Fe₂O₃ and/or CeO₂ content are usually 0-5 weight % each, whereby amounts of 0-1 and especially 0-0.5 weight % are preferred. The content of MnO₂ and/or Nd₂O₃ is 0-5 weight %, whereby amounts of 0-2, especially 0-1 weight % are preferred. The components Bi₂O₃ and/or MoO₃ are each contained in amounts of 0-5 weight %, preferably 0-4 weight %. As₂O₃ and/or Sb₂O₃ are each contained in the inventive glass in an amount of 0-1 weight %, whereby the minimum contents would preferably be 0.1, especially 0.2 weight %. The total content of Fe₂O₃, CeO₂, TiO₂, PbO, As₂O₃ and Sb₂O₃ would preferably amount to 0.1-10 weight %, especially preferably >1-8 weight %. In a preferred embodiment the glass according to the invention contains possibly low amounts of SO₄²⁻ of 0-2 weight %, as well as Cl⁻ and/or F⁻, also always in an amount of 0-2 weight % each. This means that the glass contains As₂O₃ and/or Sb₂O₃ in an amount of 0.1-1 weight %, especially 0.2-1 weight %.

In accordance with the first and the second embodiment the glasses are especially suitable for the production of flat glass, particularly in the float process, whereby the production of tube glass is especially preferred. It is especially suitable for the production of tubes having a diameter of at least 0.5 mm, especially at least 1 mm and a maximum of 2 cm, especially a maximum of 1 cm. Especially preferred tube diameters are between 2 mm and 5 mm. It has been demonstrated that tubes of this type possess a wall thickness of at least 0.05 mm, especially at least 0.1 mm, whereby at least 0.2 mm is particularly preferred. Maximum wall thicknesses are 1 mm at most, whereby wall thicknesses of <0.8 mm or <0.7 mm at most are preferred.

The glasses cited in this application, especially borosilicate glasses, are especially suitable for use in gas discharge tubes, such as fluorescent lamps, especially miniaturized fluorescent lamps. They are especially suitable for illumination, especially backlighting of electronic display units such as displays and LCD screens as are used for example in cell phones and computer monitors and find application as a light source in the production of liquid crystal displays (LCD) as well as backlit displays such displays are “Non-emitter”=not self-illuminating displays. Such fluorescent lights have very small dimensions for these applications and accordingly, the lamp glass thickness is very insignificant. Preferred displays, such as screens are so-called flat screen displays, as used in laptops, especially flat backlight arrangements. Halogen-free light devices are especially preferred, for example the type that is based on the discharging of xenon atoms (xenon lamps). This arrangement has proven to be environmentally friendly.

The utilized glasses according to the invention preferably possess low dielectric characteristics. The relative permittivity, or the dielectric constant (DZ) at 1 MHz at 25° C. is higher than 2, preferably higher than 3 and higher than 4 and especially preferably higher than 5. Higher than 6 is especially preferred. The dielectric dissipation factor tan δ[10^{″4}] is at 120 maximum and preferably lower than 100. Especially preferred are dissipation factors of below 80, whereby values of below 50 and below 30 are especially suitable. Values of less than 15 are especially desirable.

The glasses cited for use with the light devices according to the invention are particularly suitable for utilization in fluorescent lamps having external electrodes, as well as in fluorescent lamps where the electrodes are fused with the lamp glass and penetrate through said glass, as is the case for example in Kovar alloys, molybdenum and wolfram, etc. In the instance of external electrodes these may, for example be formed through an electro-conductive paste.

An additionally preferred application for the glasses described herein is in the form of flat glass for flat gas discharge lamps.

Said glasses are preferably formed initially to a semi-finished product. The production of the semi-finished products occur through a hot forming process, for example, directly from the melted mass. A tube is produced whereby the liquid glass runs from the melting tank onto a so-called “Danner” blow pipe and is drawn from there into a tube. The tube may also be produced by other processes, for example by way of the Velo-draw or A-draw. Experts are familiar with these processes.

Flat glass may be produced in an up-draw or down-draw process, or in the float process. These processes are also known to the expert. Hollow glass may be pressed or blown.

No defined cooling of the glass occurs in the aforementioned processes. For example, in the tube drawing process the glass cools to room temperature shortly after it has left the “Danner” blow pipe. There is no, or only insignificant “cooling”.

As already described, glasses that have been subjected to a temperature conditioning for the purpose of setting the UV edge can be used. The temperature conditioning permits adjustment of the UV edge—that is UV blocking—as well as the transmission, especially the dispersion of the glass. Tempering at lower temperatures is especially desirable, if the UV edge is to be adjusted precisely, since a better process control is ensured over the longer time frame.

The appropriate adjustment of the UV edge may also be accomplished in a multi-step process as is common, for example, in the production of fluorescent lamps. This temperature after-treatment may be integrated into the further processing of the tube. For example, in the production of so-called miniaturized gas discharge lamps, or fluorescent lamps for backlights, at least one additional temperature treatment occurs, during which the glass is heated partially or entirely. Examples for these types of processes are the alignment of the glass tube, the compensation of production based settle marks in the glass tube and burning in of the fluorescent layer and the sealing of the electrodes.

The temperature after-treatment may be carried out as a single treatment at a defined temperature, whereby a shorter time span is sufficient at a higher temperature.

This tempering step may also be achieved by cycling through a defined temperature profile, whereby varying heating rates and stop times at certain temperatures are possible.

The displacement of the UV edge does not have to occur through a subsequent tempering step, but may also be achieved immediately after melting the glass, whereby the glass is held at a tempering temperature for a certain amount of time during the hot forming process, or is subjected to a defined cooling rate, preferably <500 K/min., particularly preferably <10 K/min, especially preferably <1 K/min., for example 0.3 K/min (20 K/h). During the production process the cooling rate would preferably be less than 1000 K/min, preferably less than 500 K/min., especially preferably less than 100 K/min and most desirably less than 10 K/min. Most preferably, the cooling rate would be less than 1 K/min.

Combinations of a tempering treatment immediately after melting, during the hot forming process, together with a subsequent tempering process are also feasible. In this situation, subsequent tempering may occur at temperatures, whereby T_{H} is in the range of Tg <T_{H}<Tg+400° C., and whereby Tg designates the transformation temperature, for example according to Schott “Guide to Glass”, Heinz G. Pfaender, Chapman and Hall 1996, page 20—page 22. A suitable time span for the after-tempering is selected and would preferably be within the range of several seconds to 120 minutes.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a light device, of one embodiment of the present invention with a so-called backlight with electrodes, which lead into the interior of the glass bulb;

FIG. 2 illustrates the basic form of a reflecting base or support and substrate plate for a miniaturized backlight arrangement of the light device of FIG. 1;

FIG. 3 shows a backlight arrangement with electrodes on the outside;

FIG. 4 shows a display arrangement with side-mounted fluorescent lamps; and

FIG. 5 is a diagram, showing the displacement of the UV edge by a tempering process.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

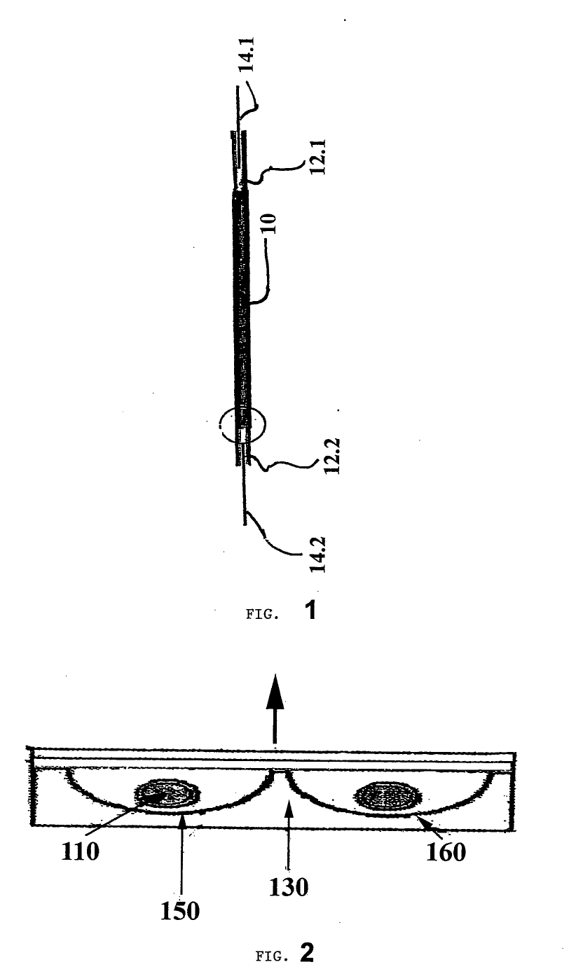

Referring now to the drawings, and more particularly to FIG. 1 there is illustrated a principle view of a low pressure discharge lamp, especially a fluorescent lamp, most especially a miniaturized fluorescent lamp. FIG. 1 illustrates a so-called backlight lamp that is produced from a tube of glass. A mid section 10 is largely transparent and represents the lamp body. Metal wires 14.1 and 14.2 of the lead-throughs are inserted into two open ends 12.1 and 12.2. These may, for example be fused with the transparent tube glass during a tempering process.

It is preferred if the glass is selected so that the expansion coefficient of the glass in the area of the lead-throughs coincides largely with the expansion coefficient of metal wires 14.1 and 14.2.

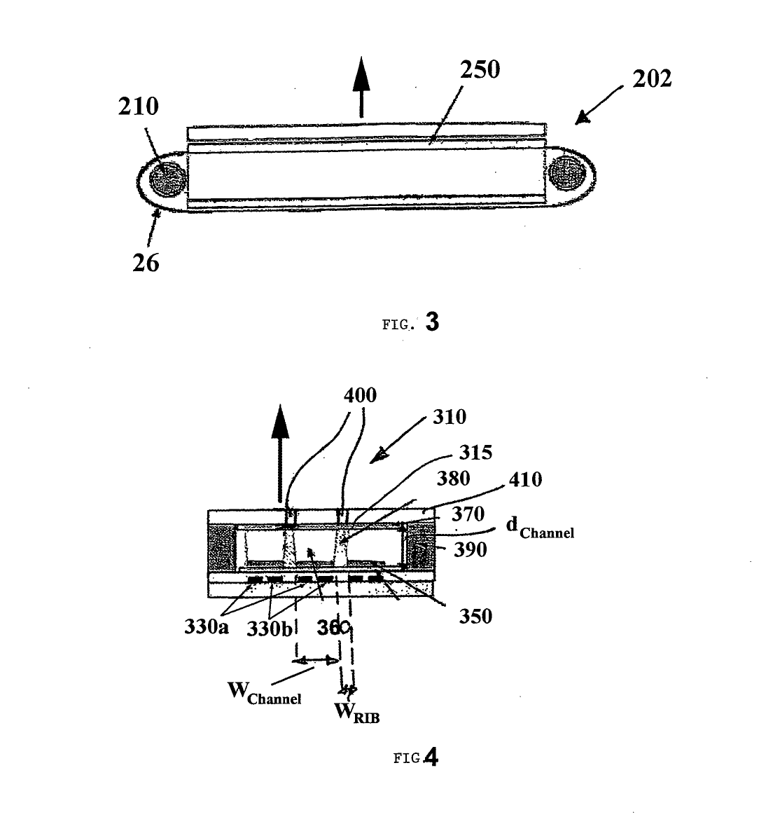

FIGS. 2-4 illustrate application examples of the backlight lamps that are produced in accordance with the present invention. Specifically, FIG. 2 shows a special utilization for such applications, whereby individual miniaturized fluorescent tubes 110, consisting of the glasses in accordance with those described above, are utilized parallel to each other and are located in a plate 130 in which there are indentations 150, which reflect the transmitted light on the display. A reflective layer 160 is applied on top of reflecting plate 130, which acts as a type of reflector by evenly scattering the light which is radiated from fluorescent tube 110 in the direction of plate 130, thereby ensuring a homogenous illumination of the display. This type of arrangement is preferred for larger displays, for example TVs. In accordance with the current invention the plate may be a polymer, for example a polycarbonate or methacrylate (PMMA).

In accordance with the design variation illustrated in FIG. 3, fluorescent tube 210 may also be mounted toward the outside on display 202, whereby the light then is advantageously evenly released over the display by way of a light transporting plate 250—a so-called LGP (light guide plate). Light transporting plates of this type possess a rough surface over which the light is released. In accordance with the current invention, the plate may be manufactured from a polymer, for example on a cyclo-olefine base. The fluorescent tubes may have external or internal electrodes.

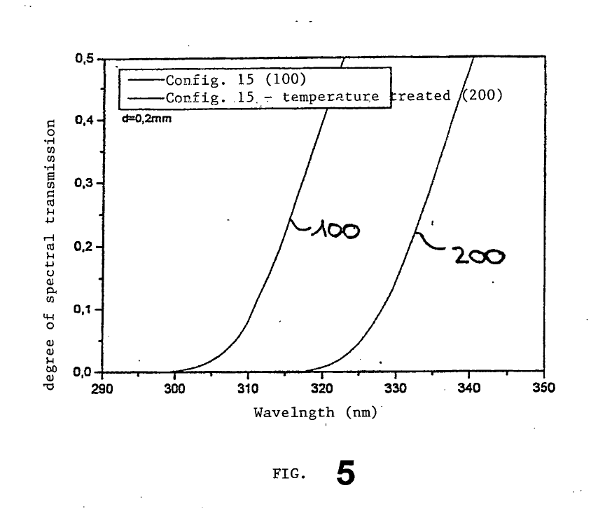

In addition it is also possible to utilize the present invention for such backlight arrangements whereby light producing unit 310 is located immediately in a structured piece 315. This arrangement is depicted in FIG. 4. This structuring is configured so that channels having a predetermined depth and predetermined width (d_{channel} or W_{channel}), and in which the discharge illumination substance 380 is located, are created in said piece by way of parallel ribs or so-called barriers 380 having a predetermined width (W_{rib}). The channels, together with a panel 370 that is covered in a phosphorous layer, form radiation chambers 360.1, 360.2, 360.3, 360.4 and 360.5.

The backlight arrangement illustrated in FIG. 4 is a gas discharge lamp without electrodes, in other words there are no lead-throughs, only exterior electrodes 330a and 330b. Depending upon the system configuration, the cover plate or panel 410 may be an opaque diffuser panel 410 or a clear transparent panel 410. Diffuser plate 410 according to the present invention may consist of a polymer on a cyclo-olefine basis, preferably Topas®.

The electrode-free lamp system illustrated in FIG. 4 is known as a so-called EEFL system (external electrode fluorescent lamp). The previously described arrangements for a large flat backlight and are therefore also described as flat backlight.

FIG. 5 illustrates the displacement of the UV edge for a glass having the following composition (Design configuration 15)

| | |
|---|---|
| SiO₂ | 64.35 |
| B₂O₃ | 19.0 |
| Al₂O₃ | 2.65 |
| Li₂O | 0.65 |
| Na₂O | 0.70 |
| K₂O | 7.45 |
| ZnO | 0.60 |
| As₂O₃ | 0.10 |
| TiO₂ | 4.50 |

The glass is produced according to the Danner procedure and is cooled very quickly, that is from approximately 1100° C. to 300° C. in less than one minute. The UV edge of this glass, having a thickness of d=0.2 mm and a transmission T <0.1% was at 302 nm. The curve is identified in FIG. 5 as 100. As can be seen clearly from the transmission spectrum, the slowly cooled sample, that is the sample that was cooled at 20 K/h, has a UV edge of 320 nm and inasmuch comprises the 313 nm line of the mercury lamp. The transmission curve of the slowly cooled sample is identified as 200. The TiO₂ content is 4.5 weight %. The glass tube has a diameter of 3 mm, the glass thickness is 0.2 mm. In this application the UV edge is identified by a transmission degree of T <0.1%.

Alternatively to slow cooling, an after-tempering process may be used.

The current invention is further explained below with the assistance of examples which clarify the inventive science, but which are not intended in any way to restrict said science.

### EXAMPLES

Tables 1 and 2 below show glass compositions for fluorescence lamps with exterior electrodes, as well as the quotient tan δ DZ which is clearly set below 5. DZ refers to the dielectric constant.

TABLE 1

| Glass Type | Config. 1 | Config. 2 | Config. 3 | Config. 4 | Config. 5 | Config. 6 | Config. 7 |
|---|---|---|---|---|---|---|---|
| SiO₂ | 59.90 | 61.25 | 50.60 | 35.00 | 32.10 | 58.00 | 70.20 |
| B₂O₃ | 4.20 | 0.25 | 13.40 | | 2.40 | | 27.10 |
| Al₂P₃ | 14.30 | 16.50 | 11.80 | | | 1.50 | 0.70 |
| Li₂O | | | | | | | |
| Na₂O | | | | | | 4.30 | |
| K₂O | | | | 5.00 | 4.00 | 8.70 | 1.20 |
| MgO | 2.50 | | | | | | |
| CaO | 10.30 | 13.40 | | | | | |
| SrO | | | | | | | |
| BaO | 8.80 | 7.60 | 24.20 | | | | 0.80 |
| ZnO | | | | | | | |
| PbO | | | | 60.00 | 61.50 | 27.50 | |
| TiO₂ | | | | | | | |
| ZrO₂ | | 1.00 | | | | | |
| CeO₂ | | | | | | | |
| F | | | | | | | |
| Fe₂O₃ | | | | | | | |
| Sum | 100.00 | 100.00 | 100.00 | 100.00 | 100.00 | 100.00 | 100.00 |
| Quotient tan | 1.8 | 2.3 | 1.5 | 0.9 | 0.9 | 1.7 | 2.3 |
| (delta) DZ | | | | | | | |
| (dielectric | | | | | | | |
| constant) | | | | | | | |

TABLE 2

| Glass Type | Config. 8 | Config. 9 | Config. 10 | Config. 11 | Config. 12 | Config. 13 | Config. 14 |
|---|---|---|---|---|---|---|---|
| SiO₂ | 59.90 | 57.00 | 60.80 | 61.60 | 63.80 | 64.50 | 5.3 |
| B₂O₃ | 5.40 | 7.90 | 6.50 | 7.80 | 9.00 | 9.00 | 15.00 |
| Al₂P₃ | 15.50 | 16.80 | 16.00 | 16.20 | 16.50 | 15.00 | 5.00 |
| Li₂O | | | | | | | |
| Na₂O | | | | | | | |
| K₂O | | | | | | | |
| MgO | 5.00 | 5.10 | 5.30 | 2.70 | 4.50 | 2.80 | 3 |
| CaO | 7.20 | 2.10 | 7.40 | 8.20 | 3.00 | 5.00 | |
| SrO | | 6.60 | | | 3.20 | | |
| BaO | 1.00 | 3.30 | 1.00 | 350 | | 3.20 | 71.2 |
| ZnO | 5.40 | | 2.00 | | | | |
| PbO | | | | | | 27.50 | |
| TiO₂ | | 0.50 | | | | | |
| ZrO₂ | 1.00 | 0.50 | 1.00 | | | | |
| CeO₂ | | 0.20 | | | | | |
| F | | | | | | | |
| Fe₂O₃ | | | | | | | 0.5 |
| Sum | 100.00 | 100.00 | 100.00 | 100.00 | 100.00 | 100.00 | 100 |
| Quotient tan | | 2.4 | | | | | |
| (delta) DZ | | | | | | | |
| (dielectric | | | | | | | |
| constant) | | | | | | | |

The current invention introduces a system for the first time which makes a combination of light device and light distribution unit possible, whereby no brittleness of synthetic components, especially polymers in the light distribution unit results, even though additional protective UV layers generally are emitted from the light device or devices and no UV absorbers are added to the synthetic materials. Glasses are utilized where a displacement of the UV edge was achieved through an appropriate temperature treatment, whereby even at low TiO₂ contents, a UV absorption in the range of more than 313 nm is achieved. A benefit of the current invention is that the UV edge in glasses can be adjusted or when compared to rapidly cooled samples can be displaced toward greater wavelengths, based on a defined cooling or tempering, or in other words based on the control of certain redox (oxidation reduction) conditions as a result of cooling or tempering. For light devices having exterior electrodes, custom glasses having a

$$\frac{tan δ}{{ɛ}^{′}} value < 5$$

may be used in the system, in order to achieve the highest possible efficiency factor of the light device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for backlighting of one of displays and screens, comprising
at least one light device including a glass body in the form of a hollow body with an inside and an outside; and
a light distribution unit containing at least one polymer, whereby said glass body is made of a glass composition that is UV blocking, said glass body being at least partially transparent and having a transmission degree T <0.1 for wavelengths <340 nm.

2. The system of claim 1, wherein said at least one polymer is selected from the group consisting of Polyvinylchloride (PVC), polystyrene (PS), polyethylene (PE), polypropylene (PP), polyamide (PA), polycarbonate (PC), polymide, polyetherketone (PEK, PEEK, PAEK), polyphenylene sulfide (PPS), styrene-acrylonitrile-copolymer (SAN), polybuteneterephthalate (PBT), polymethylmethacrylate (PMMA), polycarbonates and polymers on cycloolefin base, and compounds thereof.

3. The system of claim 2 wherein said at least one polymer is selected from polymethylmethacrylate (PMMA), polymers on cycloolefin base and their compounds.

4. The system of claim 2, wherein said cycloolefin base polymer is selected from a list consisting of cyclic olefin polymers and cyclic olefin copolymers and their compounds.

5. The system of claim 1, wherein said light distribution unit is one of a flat plate and panel.

6. The system of claim 5, wherein said one of a flat plate and panel is one of a diffuser plate, a diffuser panel and a light guiding (LGP) plate.

7. The system of claim 1, wherein said at least one light device is a discharge lamp.

8. The system of claim 7, wherein said discharge lamp includes a discharge chamber containing discharge substances, said discharge substances including at least one of mercury, rare earth ions and xenon.

9. The system of claim 8, wherein said glass body includes a fluorescent layer applied to said inside of said glass body.

10. The system of claim 1, wherein said transmission degree is T <0.1 for wavelengths of <320 nm.

11. The system of claim 1, wherein said glass body is temperature treated, in order to adjust the UV edge of said glass body.

12. The system of claim 11, wherein said temperature treatment occurs such that said glass body is subjected to one of a slow cool-down at a cooling rate of less than 500 K/min. and a warm-up over a period of time to a predetermined temperature, whereby at least one of said time period, said predetermined temperature and said cooling rate are selected so that said glass body shows a movement of the UV-edge of more than 5 nm as compared to a rapidly cooled glass tube using a cooling rates >500 K/min

13. The system of claim 12, wherein said movement of the UV-edge is more than 10 nm.

14. The system of claim 1, wherein said glass body comprises the following composition:

| | | |
|---|---|---|
| SiO₂ | 55-85 | Weight % |
| B₂O₃ | >0-35 | Weight % |
| Al₂O₃ | 0-10 | Weight % |
| Li₂O | 0-10 | Weight % |
| Na₂O | 0-20 | Weight % |
| K₂O | 0-20 | Weight %, whereby the |
| Σ Li₂O + Na₂O + K₂O | 0-25 | is Weight %, and |
| MgO | 0-8 | Weight % |
| CaO | 0-20 | Weight % |
| SrO | 0-5 | Weight % |
| BaO | 0-30 | Weight %, whereby the |
| Σ MgO + CaO + SrO + BaO | 0-30 | Weight %, is |
| TiO₂ | 0-10 | Weight %, |
| ZrO₂ | 0-3 | Weight % |
| CeO₂ | 0-1 | Weight-% |
| Fe₂O₃ | 0-1 | Weight % |
| WO₃ | 0-3 | Weight % |
| Bi₂O₃ | 0-3 | Weight % |
| MoO₃ | 0-3 | Weight % |

15. The system of claim 14, wherein said BaO is 0 to 5 weight %.

16. The system of claim 14, wherein said Σ MgO+CaO+SrO+BaO is 0-20 weight %.

17. The system of claim 14, wherein said TiO₂ is 0-10 weight %.

18. The system of claim 1, wherein said glass body has a glass composition that is to be used in said light device having exterior electrodes has a quotient from a loss angle tan δ and a dielectric constant ε′ of
$$\frac{tan δ}{{ɛ}^{′}} < 5.$$

19. The system of claim 18, wherein said quotient is <4.

20. The system of claim 19, wherein said quotient is <3.

21. The system of claim 20, wherein said quotient is <2.5.

22. The system of claim 21, wherein said quotient is <1.

23. The system of claim 18, characterized in that at least one highly polarizable element in oxidic form is integrated into said glass composition, said at least one highly polarizable element in oxidic form being selected from a list consisting of the oxides of Ba, Cs, Hf, Ta, W, Re, Os, Ir, Pt, Pb, Bi, La, Ce, Pr, Nd, Sm, Eu, Gd, Th, Dy, Ho, Er, Tm, Yb and Lu.

24. The system of claim 23, wherein said at least one highly polarizable element is present in oxidic form in an amount of at least 8 weight %.

25. The system of claim 24, wherein said at least one highly polarizable element is present in oxidic form in an amount of at least 12 weight %.

26. The system of claim 25, wherein said at least one highly polarizable element is present in oxidic form in an amount of at least 15 weight %.

27. The system of claim 26, wherein said at least one highly polarizable element is present in oxidic form in an amount of at least 20 weight %.

28. The system of claim 27, wherein said at least one highly polarizable element is present in oxidic form in an amount of at least 25 weight %.

29. The system of claim 28, wherein said at least one highly polarizable element is present in oxidic form in an amount of at least 35 weight %.

30. The system of claim 29, wherein said at least one highly polarizable element is present in oxidic form in an amount of at least 40 weight %.

31. The system of claim 18, wherein said glass composition includes the following composition:

| | | |
|---|---|---|
| SiO₂ | 55-85 | Weight % |
| B₂O₃ | >0-35 | Weight % |
| Al₂O₃ | 0-25 | Weight % |
| Li₂O | <1.0 | Weight % |
| Na₂O | <3.0 | Weight % |
| K₂O | <5.0 | Weight % whereby |
| Σ Li₂O + Na₂O + K₂O | <5.0 | is Weight %, and |
| MgO | 0-8 | Weight % |
| CaO | 0-20 | Weight % |
| SrO | 0-20 | Weight % |
| BaO | 0-80 | Weight % |
| TiO₂ | 0-10 | Weight % |
| ZrO₂ | 0-3 | Weight % |
| CeO₂ | 0-10 | Weight % |
| Fe₂O₃ | 0-3 | Weight % |
| WO₃ | 0-3 | Weight % |
| Bi₂O₃ | 0-80 | Weight % |
| MoO₃ | 0-3 | Weight % |
| ZnO | 0-15 | Weight % |
| PbO | 0-70 | Weight %, whereby |

the ΣAl₂O₃ + B₂O₃ + BaO + PbO + Bi₂O₃ is 15-80
weight %, and whereby at least one of Hf,
Ta, W, Re, Os, Ir, Pt, La, Pr, Nd, Sm, Eu,
Gd, Tb, Dy, Ho, Er, Tm, Yb and Lu are present in
oxidic form at a content of 0-80 weight %.

32. The system of claim 31, wherein said Al₂O₃ is 0 to 20 weight %.

33. The system of claim 31, wherein said BaO is 0-60 weight %.

34. The system of claim 31, wherein said TiO₂ is 0.5-10 weight %.

35. The system of claim 31, wherein said Fe₂O₃ is 0-1 weight %.

36. The system of claim 31, wherein said ZnO is 0-5 weight %.

37. The system of claim 18, wherein said glass composition includes the following composition:

| | | |
|---|---|---|
| SiO₂ | 55-85 | Weight % |
| B₂O₃ | >0-35 | Weight % |
| Al₂O₃ | 0-20 | Weight % |
| Li₂O | <0.5 | Weight % |
| Na₂O | <0.5 | Weight % |
| K₂O | <0.5 | Weight %, whereby |
| Σ Li₂O + Na₂O + K₂O | <1.0 | is Weight %, and |
| MgO | 0-8 | Weight % |
| CaO | 0-20 | Weight % |
| SrO | 0-20 | Weight % |
| BaO | 15-60 | Weight % |
| Σ MgO + CaO + SrO + BaO | 15-70 | Weight % |
| TiO₂ | 0-10 | Weight % |
| ZrO₂ | 0-3 | Weight % |
| CeO₂ | 0-10 | Weight % |
| Fe₂O₃ | 0-1 | Weight %′ |
| WO3 | 0-3 | Weight % |
| Bi₂O₃ | 0-80 | Weight % |
| MoO₃ | 0-3 | Weight % |
| ZnO | 0-10 | Weight % |
| PbO | 0-70 | Weight %, whereby |

the Σ Al₂O₃ + B₂O₃ + BaO + Cs₂O + PbO + Bi₂O₃ is 15-80
weight %, and refining agents.

38. The system of claim 37, wherein said BaO is 20 to 35 weight %.

39. The system of claim 37, wherein said Σ MgO+CaO+SrO+BaO is 20-40 weight %.

40. The system of claim 37, wherein said TiO₂ is >0.5-10 weight %.

41. The system of claim 37, wherein said CeO₂ is 0-1 weight %.

42. The system of claim 37, wherein said ZnO is 0-5 weight %.

43. The system of claim 18, wherein said glass composition includes the following composition:

| | | |
|---|---|---|
| SiO₂ | 35-65 | Weight % |
| B₂O₃ | 0-15 | Weight % |
| Al₂O₃ | 0-20 | Weight % |
| Li₂O | 0-0.5 | Weight % |
| Na₂O | 0-0.5 | Weight % |
| K₂O | 0-0.5 | Weight %, whereby the |
| Σ Li₂O + Na₂O + K₂O | 0-1 | Is Weight %, and |
| MgO | 0-6 | Weight % |
| CaO | 0-15 | Weight % |
| SrO | 0-8 | Weight % |
| BaO | 1-20 | Weight % |
| TiO₂ | 0-10 | Weight % |
| ZrO₂ | 0-1 | Weight % |
| CeO₂ | 0-0.5 | Weight % |
| Fe₂O₃ | 0-0.5 | Weight % |
| WO₃ | 0-2 | Weight % |
| Bi₂O₃ | 0-20 | Weight % |
| MoO₃ | 0-5 | Weight % |
| ZnO | 0-5 | Weight % |
| PbO | 0-70 | Weight %, whereby |

the Σ Al₂O₃ + B₂O₃ + BaO + PbO + Bi₂O₃ is 8-65 weight %,
whereby at least one of Hf, Ta, W, Re, Os, Ir, Pt, La, Pr, Nd,
Sm, Eu, Gd, Tb, Dy, Ho, Er, Tm,
Yb and Lu are present in oxidic form at a contents of 0-80
weight %, and refining agents.

44. The system of claim 43, wherein said Al₂O₃ is 5 to 15 weight %.

45. The system of claim 43, wherein said BaO is 1 to 10 weight %.

46. The system of claim 43, wherein said TiO₂ is >0.5-10 weight %.

47. The system of claim 43, wherein said ZnO is 0-3 weight %.

48. The system of claim 18, wherein said glass composition includes the following composition:

| | | |
|---|---|---|
| SiO₂ | 50-65 | Weight % |
| B₂O₃ | 0-15 | Weight % |
| Al₂O₃ | 1-17 | Weight % |
| Li₂O | 0-0.5 | Weight % |
| Na₂O | 0-0.5 | Weight % |
| K₂O | 0-0.5 | Weight %, whereby the |
| Σ Li₂O + Na₂O + K₂O | 0-1 | Is Weight %, and |
| MgO | 0-5 | Weight % |
| CaO | 0-15 | Weight % |
| SrO | 0-5 | Weight % |
| BaO | 20-60 | Weight % |
| TiO₂ | 0-1 | Weight % |
| ZrO₂ | 0-1 | Weight % |
| CeO₂ | 0-0.5 | Weight % |
| Fe₂O₃ | 0-1 | Weight % |
| WO₃ | 0-2 | Weight % |
| Bi₂O₃ | 0-40 | Weight % |
| MoO₃ | 0-5 | Weight % |
| ZnO | 0-3 | Weight % |
| PbO | 0-30 | Weight %, whereby |

the ΣAl₂O₃ + B₂O₃ + BaO + PbO + Bi₂O₃ is 10-80
weight %, whereby at least one of Hf, Ta, W,
Re, Os, Ir, Pt, La, Pr, Nd, Sm, Eu, Gd, Tb, Dy,
Ho, Er, Tm, Yb and Lu are present in oxidic
form at a content of 0-80 weight %, and refining agents.

49. The system of claim 48, wherein said BaO is 20-40 weight %.

50. The system of claim 48, wherein said Fe₂O₃ is 0-0.5 weight %.

51. The system of claim 48, wherein said PbO is 10-20 weight %.

52. The system of claim 18, wherein said glass composition includes an alkali content that is <1.0 weight %.

53. The system of claim 18, wherein said glass composition is alkali free.

54. The system of claim 18, wherein said glass composition includes BaO that is higher than 15 weight %.

55. The system of claim 54, wherein said BaO is higher than 18 weight %.

56. The system of claim 55, wherein said BaO is higher than 20 weight %.

57. The system of claim 56, wherein said BaO is between 20 weight % and 80 weight %.

58. The system of claim 57, wherein said BaO is between 20 weight % and 60 weight %.

59. The system of claim 18, wherein said glass composition includes a PbO content that is higher than 50 weight % and an alkali content that is higher than 3 weight %.

60. The system of claim 59, wherein said PbO content is higher than 60 weight %.

61. The system of claim 59, wherein said alkali content is higher than 4 weight %.

62. The system of claim 61, wherein said alkali content is higher than 5 weight %.

63. The system of claim 18, wherein if said glass composition does not contain PbO, then an alkali content is <1.0 weight %.

64. The system of claim 18, wherein if said glass composition contains PbO, then said glass composition has a BaO content is <10 weight %

65. The system of claim 64, wherein said BaO content is <5 weight %

66. The system of claim 65, wherein said BaO content is 0 weight %.

67. The system of the claim 1, wherein said light device is a fluorescent lamp, and said fluorescent lamp being at least one of an EEFL lamp and a gas discharge lamp providing illumination for one of LCD screens, computer monitors, telephone displays and displays.

68. The system of claim 1, wherein said glass body of said light device is has one of a tubular and tube-type form.

69. The system of claim 68, wherein said glass body has at least one of a diameter of <0.8 cm and a wall thickness of <1 mm.

70. The system of claim 1, wherein said glass body of said light device is a flat glass having a thickness of <1 cm.
